(19) United States
(12) Patent Application Publication
(10) Pub. No.: US 2025/0156623 A1
(43) Pub. Date: May 15, 2025

(54) SEMICONDUCTOR INTEGRATED CIRCUIT IN BACKSIDE POWER DISTRIBUTION NETWORK SEMICONDUCTOR ARCHITECTURE AND DESIGN METHOD THEREOF

(71) Applicant: SAMSUNG ELECTRONICS CO., LTD., Suwon-si (KR)

(72) Inventors: Jooyeon KWON, Suwon-si (KR); Seuonghoon Kang, Suwon-si (KR)

(73) Assignee: SAMSUNG ELECTRONICS CO., LTD., Suwon-si (KR)

(21) Appl. No.: 18/661,325

(22) Filed: May 10, 2024

(30) Foreign Application Priority Data
Nov. 13, 2023 (KR) 10-2023-0156358

(51) Int. Cl. G06F 30/398; G06F 30/394; G06F 111/20; H01L 23/522; H01L 23/528

(52) U.S. Cl. CPC G06F 30/398; G06F 30/394; H01L 23/5226; H01L 23/5286; G06F 2111/20

(57) ABSTRACT

A method of manufacturing a semiconductor integrated circuit including a first region and a remaining region excluding the first region is provided. The method includes: placing standard cells in the remaining region; generating a routing structure that connects the standard cells; placing sub-power tap cells in the first region based on a predefined design rule; and verifying whether the sub-power tap cells and the standard cells comply with the predefined design rule.

### CROSS-REFERENCE TO RELATED APPLICATION

This application claims priority to Korean Patent Application No. 10-2023-0156358, filed in the Korean Intellectual Property Office, on Nov. 13, 2023, the disclosure of which is incorporated by reference herein in its entirety.

### BACKGROUND

The present disclosure relates to a semiconductor integrated circuit in a backside power distribution network (BSPDN) semiconductor structure, and a method for designing the same.

By providing a semiconductor device, such as an integrated circuit, that includes signal wires and active devices for signal routing on a front of a wafer and providing a power distribution network (PDN) for electric power supply on the back of the wafer, a BSPDN semiconductor structure separates the signal wire from the power distribution network provided on the wafer. Such a BSPDN semiconductor structure may minimize routing congestion and reduce the area of the semiconductor structure.

Integrated circuits that process digital signals may be designed based on standard cells. A functional circuit may be formed by placing and routing standard cells such that the integrated circuit implements a desired function.

As the demand for high performance, higher speed and/or multi-functionality for semiconductor devices increases, the integration of semiconductor devices is increasing. With the trend toward higher integration of semiconductor devices, the number of design rules that need be considered in the layout design process is increasing. These design rules need be considered during placement of the standard cells.

### SUMMARY

One or more embodiments provide a design method of a semiconductor integrated circuit in which a power tap cell is placed after placing a standard cell.

One or more embodiments provide a design method for a semiconductor integrated circuit that reduces design rule constraints for standard cells during the placement process of the standard cells.

One or more embodiments provide a design method for a semiconductor integrated circuit to reduce the number of cells stored in a cell library.

One or more embodiments provide a semiconductor integrated circuit of a backside power distribution network semiconductor structure designed using the design method of the integrated circuit.

According to an aspect of an embodiment, a method of manufacturing a semiconductor integrated circuit including a first region and a remaining region excluding the first region, includes: placing standard cells in the remaining region; generating a routing structure that connects the standard cells; placing sub-power tap cells in the first region based on a predefined design rule; and verifying whether the sub-power tap cells and the standard cells comply with the predefined design rule.

According to another aspect of an embodiment, a semiconductor integrated circuit includes: a first power rail extending in a first direction; a second power rail that extends in the first direction and is spaced apart from the first power rail in a second direction that crosses the first direction; a first standard cell between the first power rail and the second power rail; and a first power tap cell adjacent to the first standard cell in the first direction, and including a first region and a second region, the first region including a first via electrically connecting an external power wire and the first power rail, and the second region including a second via electrically connecting an external power wire and the second power rail, a first active layer having a first width in the second direction, and a second active layer having a second width in the second direction that is different from the first width.

According to another aspect of an embodiment, a semiconductor device includes: a substrate; a first layer on a first side of the substrate and including a power distribution network; and a second layer on a second side of the substrate and including a first power rail extending in a first direction, a first through silicon via extending through the substrate in a second direction that crosses the first direction from the power distribution network to the first power rail and having a first length in the first direction, and a second through silicon via contacting the first through silicon via, adjacent the first through silicon via in the first direction, extending through the substrate in the second direction from the power distribution network to the first power rail, and having the first length in the first direction.

### BRIEF DESCRIPTION OF DRAWINGS

The above and other aspects will be more apparent from the following description of embodiments taken in conjunction with the accompanying drawings.

FIG. 1 is a perspective view of a frontside power distribution network (FSPDN) semiconductor structure and a backside power distribution network (BSPDN) semiconductor structure according to an embodiment.

FIG. 2 illustrates a BSPDN semiconductor structure according to an embodiment.

FIG. 3 illustrates a BSPDN semiconductor structure according to an embodiment.

FIG. 4 schematically illustrates a part of an integrated circuit formed in a signal wiring layer according to an embodiment.

FIG. 5 is a flowchart provided for description of a design method of a semiconductor device according to a comparative example.

FIG. 6 is a top plan view of a power tap cell and a standard cell according to the comparative example.

FIG. 7 is provided for description of the design rule for the power tap cell.

FIG. 8 is a flowchart for description of a design method of a semiconductor device according to an embodiment.

FIG. 9 schematically illustrates a part of an integrated circuit formed in a signal wiring layer according to an embodiment.

FIG. 10 is a top plan view of a sub-power tap cell provided by a cell library according to an embodiment.

FIG. 11 schematically illustrates a part of an integrated circuit formed in a signal wiring layer according to an embodiment.

FIG. 12 is a flowchart of a placement method of sub-power tap cells according to an embodiment.

FIG. 13 is a flowchart of a placement method of sub-power tap cells according to an embodiment.

FIG. 14 schematically illustrates a part of an integrated circuit according to an embodiment for description of the placement method of the sub-power tap cell of FIG. 13.

FIG. 15 is a flowchart of a placement method of sub-power tap cells according to an embodiment.

FIG. 16 schematically illustrates a part of an integrated circuit according to an embodiment for description of the placement method of the sub-power tap cell of FIG. 15.

FIG. 17 schematically illustrates a design system of a semiconductor device according to an embodiment.

### DETAILED DESCRIPTION

Hereinafter, embodiments will be described in more detail with reference to the accompanying drawings. The same reference sign is designated to the same component in the drawing, and duplicate descriptions for the same component are omitted.

Embodiments described herein are example embodiments, and thus, the present disclosure is not limited thereto, and may be realized in various other forms. Each embodiment provided in the following description is not excluded from being associated with one or more features of another example or another embodiment also provided herein or not provided herein but consistent with the present disclosure. For example, the dimensions of components are not limited to a disclosed range or value but may vary depending on process conditions and/or desired device properties. In addition, in the following description, formation of a first structure on or above a second structure may include embodiments in which the first and second structures are formed by direct contact, and may also include embodiments in which an additional structure is formed between the first and second structures such that the first and second structures do not contact directly. For simplicity and clarity, various structures may be arbitrarily drawn at different scales. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In addition, terms with a spatial relationship, such as “below,” “lower,” “under,” “above,” and “top,” may be used for convenience in description of a relationship for other elements or structures of an element or structure illustrated in the drawing.

Accordingly, the drawings and description are to be regarded as illustrative in nature and not restrictive, and like reference numerals designate like elements throughout the specification. In flowcharts described with reference to the drawings, the order of operations may be changed, several operations may be merged, certain operations may be divided, and certain operations may not be performed.

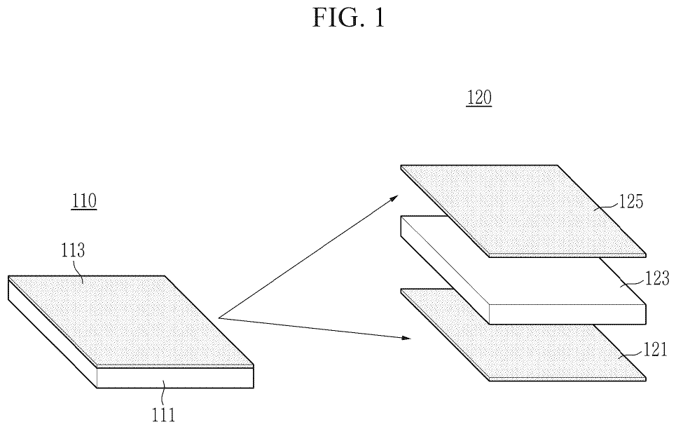

FIG. 1 is a perspective view of a frontside power distribution network (FSPDN) semiconductor structure and a backside power distribution network (BSPDN) semiconductor structure according to an embodiment.

Referring to FIG. 1, a frontside power distribution network (FSPDN) semiconductor structure 110 includes a power distribution network (PDN) and a signal wiring layer 113 disposed on one side of a wafer 111. The power distribution network and the signal wiring layer 113 may include a power rail and signal wires. However, the FSPDN semiconductor structure 110 may cause routing congestion in the power distribution network and wires of the signal wiring layer 113, and may increase the size of the semiconductor structure 110.

A backside power distribution network (BSPDN) semiconductor structure 120 according to an embodiment may include a signal wiring layer 125 that provides a signal wire provided to a first side (e.g., a front side) of the wafer 123 and a PDN layer 121 including a power rail metal layer provided in a second side (e.g., a backside) of the wafer 123, facing the first side. The wafer 123 may include, for example, a silicon (Si) substrate, a glass substrate, a sapphire substrate, and the like, but this is not restrictive.

As shown in FIG. 1, the signal wiring layer 125 and the PDN layer 121 are separated from each other by the wafer 123 disposed therebetween. At least one of the signal wiring layer 125 and the PDN layer 121 may be bonded to the wafer 123 or integrated with the wafer 123 depending on embodiments. Alternatively, one or more intermediate layers may be provided between at least one of the signal wiring layer 125 and the PDN layer 121.

The BSPDN semiconductor structure 120 may prevent (or reduce) routing congestion in the signal wires by removing the PDN layer 121 from the signal wiring layer 125 and reduce the size of the semiconductor structure 120, and accordingly, a drop in current-resistance (IR) can be improved.

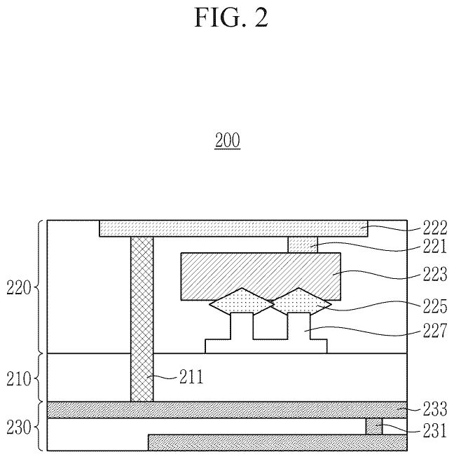

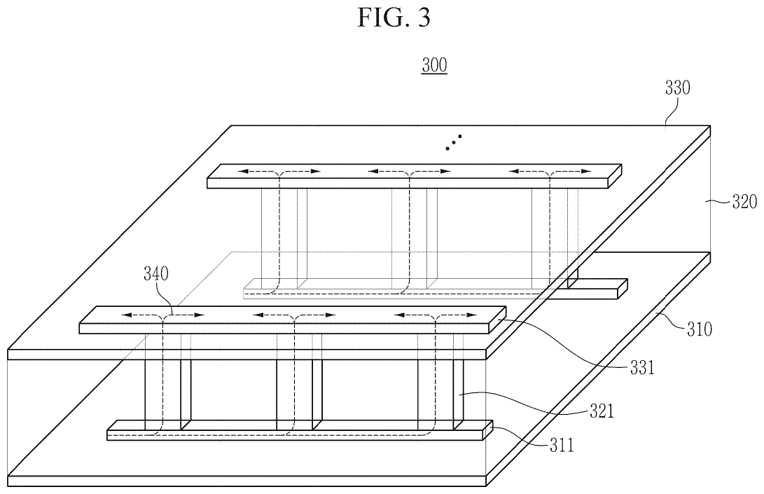

FIG. 2 and FIG. 3 illustrate the BSPDN semiconductor structure according to an embodiment. Specifically, FIG. 2 is a vertical cross-sectional view of the BSPDN semiconductor structure, and FIG. 3 shows a three-dimensional (3D) perspective view of the BSPDN semiconductor structure.

Referring to FIG. 2, the BSPDN semiconductor structure 200 may include a wafer 210, a signal wiring layer 220 on a first side of the wafer 210, and a PDN layer 230 on a second side of the wafer 210, facing the first side. The signal wiring layer 220 may be, for example, an integrated circuit including constituent elements such as active devices (e.g., transistors) or signal wires for signal routing. For example, the active devices may include active patterns 227 on an active region and source/drain patterns 225 provided on the active patterns 227. In addition, the signal wiring layer 220 may include active contacts 223 that extend in a horizontal direction parallel with the front side of the wafer 210 while contacting the source/drain patterns 225. The signal wiring layer 220 may include a power rail 222 for supplying power to the active devices. A via 221 may be provided between the power rail 222 and the active contacts 223 for electrical connection therebetween.

The PDN layer 230 may include a power rail metal layer 233 on the second side of the wafer 210. The PDN layer 230 may include vias 231 provided between the power rail metal layers 233. In addition, a through silicon via (TSV) 211 penetrates the wafer 210 and extends to the power rail 222 from the PDN layer 230. The TSV 211 may extend into the PDN layer 230.

Components included in each layer are not limited to those described, and additional components may be included or some components may be omitted, and the structure of the components included in each layer may be variously modified.

FIG. 3 is provided for description of a power source voltage supplied from the power rail metal layer 311 of the PDN layer 310. Referring to FIG. 3, in the BSPDN semiconductor structure 300, the power rail 331 on the signal wiring layer 330 may be supplied with a power source voltage from the power rail metal layer 311 of the PDN layer 310 through the TSV 321 penetrating the wafer 320. The power source voltage provided in an arrow direction 340 from the power rail metal layer 311 of the PDN layer 310 may be for driving of the active devices in the signal wiring layer 330.

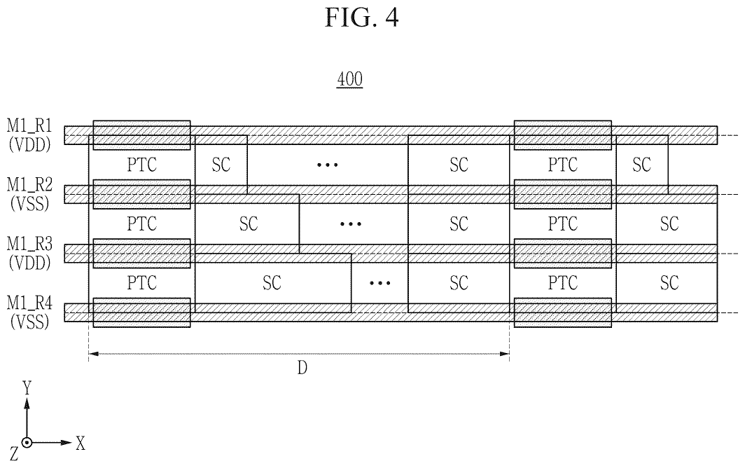

FIG. 4 schematically illustrates a part of an integrated circuit formed in the signal wiring layer. Specifically, FIG. 4 is a top plan view of the signal wiring layer 330 of FIG. 3, while shows a layout of an integrated circuit 400 including a plurality of standard cells.

Referring to FIG. 4, the integrated circuit 400 may include a plurality of power rails M1_R1, M1_R2, M1_R3, and M1_R4 extending in the X-axis direction. Each of the power rails M1_R1, M1_R2, M1_R3, and M1_R4 may be applied with a power source voltage (e.g., VDD) or a ground voltage (e.g., VSS). For example, the power rails M1_R1 and M1_R3 may be applied with the power source voltage VDD, and the power rails M1_R2 and M1_R4 may be applied with the ground voltage VSS.

Standard cells SC may be placed between the power rails M1_R1, M1_R2, M1_R3, and M1_R4 to which the power source voltage and the ground voltage are applied. The standard cell may include a logic cell, a filler cell, and the like. Here, the logic cell may refer to a logic device (e.g., AND, OR, XOR, XNOR, an inverter, and the like) that performs a specific function, and the filler cell may be a cell for maintaining well continuity between adjacent cells. The logic cells may include circuitry configured to perform logical functions.

The integrated circuit 400 may further include a power tap cell (PTC). The power tap cell PTC may be a cell for providing a voltage (e.g., a power source voltage or a ground voltage) to at least one of the power rail M1_R1, M1_R2, M1_R3, and M1_R4 from the power rail metal layer 311 (refer to FIG. 3) of the PDN layer 310 (refer to FIG. 3). The power tap cell PTC may not include a logic device, unlike the logic cell of the SC. That is, the power tap cell PTC may be a dummy cell that performs a function of applying a power to the power rails M1_R1, M1_R2, M1_R3, and M1_R4 but does not perform a logic function.

The power tap cell PTC may include a through silicon via region 411 that includes a through silicon via extending to the power rails M1_R1, M1_R2, M1_R3, and M1_R4 from the power rail metal layer 311 of the PDN layer 310. The through silicon via may have a pillar shape extending in the Z-axis direction. The power rail metal layer 311 and the power rails M1_R1, M1_R2, M1_R3, and M1_R4 may be electrically connected with each other through the through silicon via. That is, the voltage may be applied to the power rails M1_R1, M1_R2, M1_R3, and M1_R4 through the through silicon via 411 from the power rail metal layer 311. The power rails M1_R1, M1_R2, M1_R3, and M1_R4 may supply the voltage applied through the through silicon via to the standard cell SC.

The power tap cells PTC may be placed continuously in the Y-axis direction and spaced apart at regular intervals D in the X-axis direction. The interval D may be predetermined to prevent a power problem, such as the current-resistance (IR) drop and the like, from occurring in the integrated circuit 400. The placement relationship between the power tap cell PTC and the standard cells SC shown in FIG. 4 is provided as an example, and the placement between the power tap cell PTC and standard cells SC may be changed in various ways.

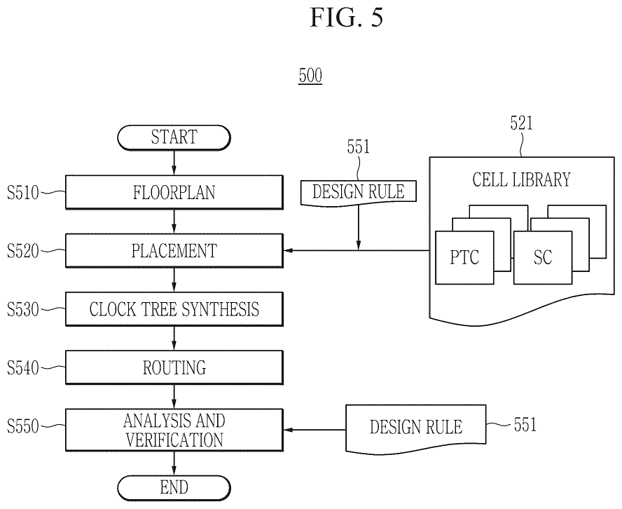

FIG. 5 is a flowchart provided for description of a design method of a semiconductor device according to a comparative example. Specifically, FIG. 5 is provided for description of a placement method of power tap cells according to a comparative example.

A design method 500 of a semiconductor device may include a floorplan operation (S510), a placement operation (S520), a clock tree synthesis (CTS) operation (S530), a routing operation (S540), and an analysis and verification operation (S550). Each operation of FIG. 5 is an operation for designing a layout of a circuit, and may be carried out by a semiconductor design tool for design and verification of an integrated circuit.

To briefly explain each operation, in the floorplan operation (S510), a logically designed schematic circuit may be physically designed by cutting and moving it. In S510, a memory or function blocks may be placed. For example, in S510, function blocks that should be placed adjacently may be identified, and a space for function blocks and memories may be allocated while considering available space and required performance.

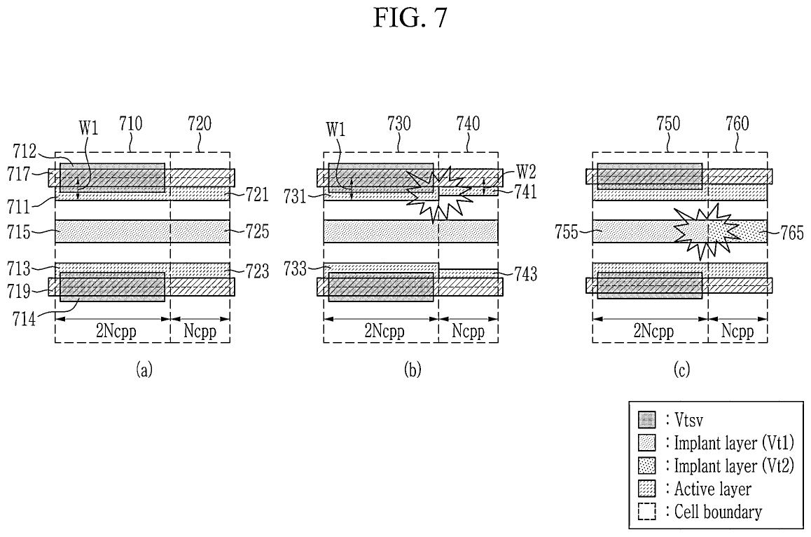

The placement operation (S520) according to the comparative example may include an operation for placing power tap cells PTC and standard cells SC. In S520, the semiconductor design tool may place the power tap cells PTC at predetermined intervals, and may place the standard cells SC in spaces remaining after the power tap cells PTC are placed. The semiconductor design tool may place the power tap cells PTC and the standard cells SC using information about the power tap cell PTC and standard cells SC stored in the cell library 521. The information on the power tap cell PTC and the standard cell SC may include function information, characteristic information, layout information, and the like. The semiconductor design tool may place the standard cells SC in consideration of interfaces between constituent elements in the semiconductor device. When placing the standard cells CS, the semiconductor design tool may further consider whether a design rule 551 predefined in relationship with the power tap cell PTC is satisfied. This will be described in detail later with reference to FIG. 7.

The CTS operation (S530) may be an operation for generating a clock distribution network for distributing a clock signal to a set of successive circuit elements of the semiconductor device.

The routing operation (S540) may be an operation for generating a routing structure including a plurality of wiring lines and a plurality of vias connecting the placed standard cells SC and macros.

The analysis and verification operation (S550) may be an operation for verifying and modifying the generated layout. Verification items may include a design rule check (DRC), which verifies whether the layout satisfies the design rule 551 that can be defined by semiconductor process requirements.

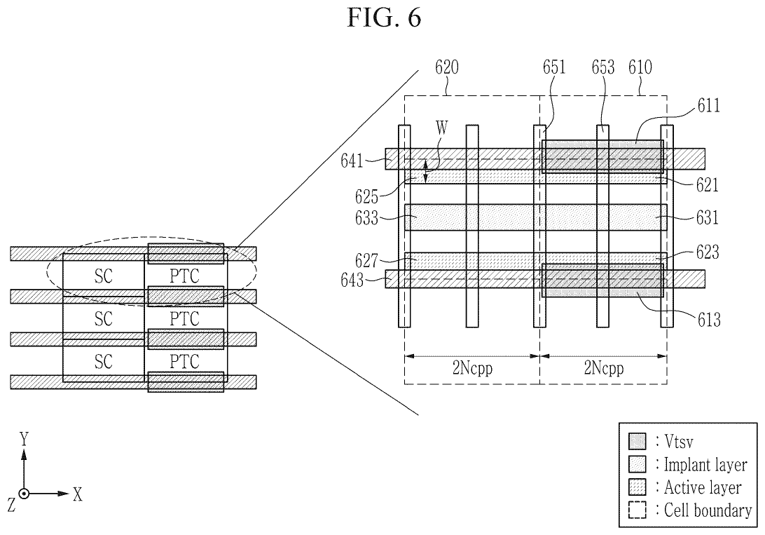

FIG. 6 is a top plan view of power tap cells PTC and standard cells SC according to the comparative example. Specifically, FIG. 6 shows an enlarged view of a part of standard cells SC disposed adjacent to the power tap cell PTC after the power tap cells PTC are placed.

As previously described, according to the comparative example, the semiconductor design tool may place the standard cells SC in a space remaining after the power tap cells PTC are placed.

The power tap cell 610 and the standard cell 620 each may include first active layers 621 and 625 and second active layers 623 and 627 respectively corresponding to active regions. For example, the first active layers 621 and 625 may be p-type metal-oxide-semiconductor field-effect transistors (PMOS) transistor regions, and the second active layers 623 and 627 may be n-type metal-oxide-semiconductor field-effect transistors (NMOS) transistor regions. The first active layers 621 and 625 may be adjacent to a first power rail 641 and the second active layers 623 and 627 may be adjacent to a second power rail 643. However, in contrast to the active layers 625 and 627 of the standard cell 620, the active layers 621 and 623 of the power tap cell 610 may not be implemented in a logic circuit. The active layers 621 and 623 of the power tap cell 610 may serve as a buffer between standard cells adjacent to the power tap cell 610. The power tap cell 610 may reduce the electrical impact of the power tap cell 610 on the surrounding standard cell 620 through the active layers 621 and 623. Widths W of the active layers 621, 623, 625, and 627 in the Y-axis direction may vary depending on the channel resistance of the transistor inside the cell and the current driving ability of the cell. In this regard, the widths W of the active layers may vary depending on the cell characteristics.

The power tap cell 610 and the standard cell 620 may include implant layers 631 and 633. The implant layers 631 and 633 represent ion implantation regions, and a threshold voltage Vt of the transistor inside the cell may depend on a depth of a well formed by ion implantation or an impurity concentration of the implant layers 631 and 633. Depending on the threshold voltage of the internal transistor, the cells may be classified into a high voltage transistor (HVT) cell, a regular voltage transistor (RVT) cell, and a low voltage transistor (LVT) cell, but this is not restrictive. That is, the impurity concentration or impurity type of the implant layers 631 and 633 may differ depending on the cell type according to the threshold voltage of the internal transistor.

The power tap cell PTC may include through silicon via regions (Vtsv) 611 and 613 that include through silicon vias overlapping the power rails 641 and 643. Power rails 641 and 643 can provide the voltage applied through the through silicon via in the through silicon via regions 611 and 613 to the standard cell 620.

According to the predefined design rule, the length of the through silicon via region 611 and 613 of the power tap cell 610 in the X-axis direction needs to satisfy a predetermined length. That is, the design rule defines a minimum length rule for the through silicon via regions 611 and 613.

The power tap cell 610 according to the comparative example may be fixed to a size of 2Ncpp (i.e., 2*N*cpp), where cpp is a contacted poly pitch and N is an integer greater than 1, according to the minimum length rule for the through silicon via regions 611 and 613. The cpp unit refers to the center-to-center distance between two immediately adjacent gates 651 and 653 along the X axis. Because the size of the power tap cell 600 according to the comparative example is fixed to 2Ncpp, a length of the active layers 621 and 623 and the implant layer 631 in the power tap cell 600 is fixed to 2Ncpp.

According to the predetermined design rule, the length of the active layers 621, 623, 625, and 627 and the implant layers 631 and 633 needs to satisfy a predetermined length. That is, the design rule defines minimum length rules for the active layers 621, 623, 625, and 627 and the implant layers 631 and 633. The minimum length of the active layers 621, 623, 625, and 627 and the implant layers 631 and 633 defined by the design rule may be Mcpp (i.e., M*cpp). Here, M may be an integer greater than 2N, but this is not restrictive. Hereinafter, it will be assumed that M is an integer greater than 2N.

A cell library 521 (refer to FIG. 5) according to the comparative example may provide the power tap cell 610 of 2Ncpp size according to the minimum length rule for the length of the through silicon via regions 611 and 613. However, the minimum length according to the minimum length rule for the active layers 621 and 623 and the implant layer 631 of the power tap cell 610 is Mcpp. Therefore, in order to satisfy this, the standard cell 620 placed adjacent to the power tap cell 610 needs include active layers 625 and 627 and an implant layer 633 that are the same as the active layers 621 and 623 and the implant layer 631 of the power tap cell 610.

FIG. 7 is provided for description of the design rule for the power tap cell. Specifically, it is provided for description of the minimum length rules for the active layer and implant layer in the relationship with the standard cell placed adjacent to the power tap cell.

For better understanding and ease of description, it is assumed that only one standard cell 720, 740, and 760 is adjacent to each power tap cell 710, 730, and 750 and a size of each standard cell 720, 740, and 760 is Ncpp, and Mcpp, which is a minimum length according to the minimum length rule for the active layer and implant layer is assumed to be 3Ncpp, but this is not restrictive.

Referring to portion (a) in FIG. 7, the power tap cell 710 may include through silicon via regions 712 and 714 overlapping power rails 717 and 719, first and second active layers 711 and 713 having a first width W1 while being adjacent to the power rails 717 and 719, and an implant layer 715 according to a first threshold voltage Vt1 of an internal transistor.

The standard cell 720 may be disposed adjacent to the power tap cell 710. The standard cell 720 may include first and second active layers 721 and 723 with the first width W1 and an implant layer 725 according to the first threshold voltage Vt1.

According to portion (a) in FIG. 7, because the power tap cell 710 and the standard cell 720 include active layers of the same width W1 and implant layers according to the same threshold voltage Vt1, lengths (3Ncpp) of the active layer of the same width W1 and the implant layer according to the same threshold voltage Vt1 satisfy Mcpp length according to the minimum length rule. Therefore, the problem of design rule violation does not occur.

Referring to portion (b) in FIG. 7, in contrast to portion (a), the standard cell 740 adjacent to the power tap cell 730 may include first and second active layers 741 and 743 of a second width W2 that is different from the first width W1 of first and second active layers 731 and 733. Therefore, the lengths (2Ncpp) of the active layers 731 and 733 of the power tap cell 730 of the same width W1 do not satisfy the minimum length (Mcpp) according to minimum length rule, and thus a design rule violation may occur. Mcpp, which is a minimum length according to the minimum length rule for the active layer is assumed to be 3Ncpp, but this is not restrictive.

The cell library needs to provide another standard cell that has the same function and size as the standard cell 740 and includes an active layer of first width W1 such that standard cell 740 can be replaced by the other standard cell with the active layer of the first width W1.

Referring to portion (c) in FIG. 7, in contrast to portion (a), the standard cell 760 adjacent to the power tap cell 750 may include an implant layer 765 according to a second threshold voltage Vt2 that is different from the first threshold voltage Vt1. Therefore, the length (2Ncpp) of the implant layer 755 of the power tap cell 750 according to the same threshold voltage Vt1 does not satisfy the minimum length (Mcpp) according to minimum length rule, and thus a design rule violation may occur. Mcpp, which is a minimum length according to the minimum length rule for the implant layer is assumed to be 3Ncpp, but this is not restrictive.

The cell library needs to provide another standard cell that has the same function and size as the standard cell 760 and includes an implant according to first threshold voltage Vt1 such that standard cell 760 can be replaced by the other standard cell including the implement layer according of the first threshold voltage Vt1.

As described above, the cell library according to the comparative example provides a power tap cell with a fixed size and fixed layers, and the semiconductor design tool according to the comparative example places standard cells after the power tap cell is placed, and thus many restrictions may occur for the standard cells adjacent to power tap cells. For example, a standard cell adjacent to a power tap cell needs to include the same active layer and implant layer as those of the power tap cell to satisfy the design rules. In addition, the cell library needs to provide an excessive number of cell types, including various active layers and various implant layers, while having the same function and size for a plurality of standard cells.

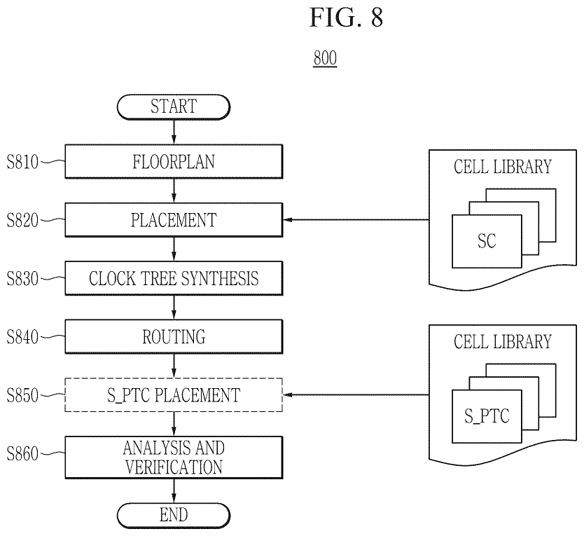

FIG. 8 is a flowchart for description of a design method of a semiconductor device according to an embodiment. Specifically, FIG. 8 is provided for description of a placement method of a power tap cell according to an embodiment. Regarding each operation in FIG. 8, descriptions that are the same or similar to those described in FIG. 5 are omitted.

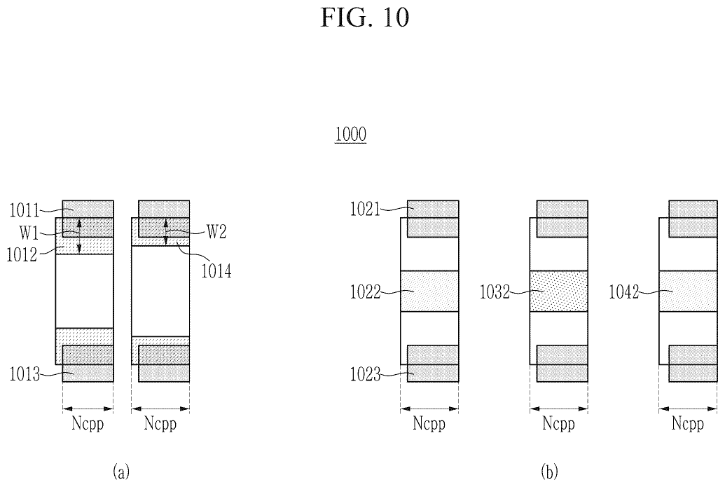

A design method 800 of a semiconductor device according to an embodiment may include a floorplan operation (S810), a placement operation (S820), a clock tree synthesis (CTS) operation (S830), a routing operation (S840), and an analysis and verification operation (S850), and may further include sub-power tap cell (S_PTC) placement operation (S850). The sub-power tap cell S_PTC refers to a cell separated with a size of Ncpp from the power tap cell of 2Ncpp size according to the comparative example, and the sub-power tap cell S_PTC will be described in detail later with reference to FIG. 10.

In the design method 800 of the semiconductor device according to an embodiment, the S_PTC placement operation (S850) may be carried out separately from the placement operation (S820) in which the standard cells SC are placed. For example, after all the standard cells SC are placed, the S_PTC placement operation (S850) may be carried out. Therefore, the semiconductor design tool does not need to consider predefined design rules regarding the relationship between the sub-power tap cells S_PTC and the standard cells SC in the placement operation (S820) for placing the standard cells SC,

Although it is illustrated in the drawing that the S_PTC placement operation (S850) is carried out after the routing operation (S840), additional operations may be further carried out before the S_PTC placement operation (S850) is performed.

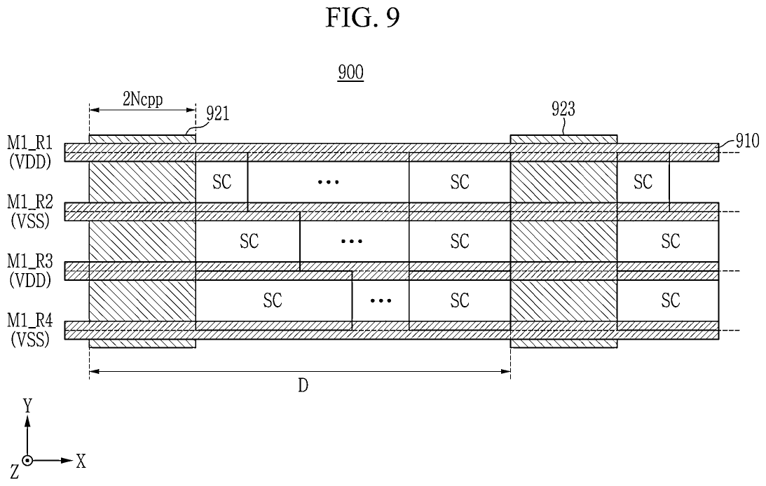

FIG. 9 schematically illustrates a part of an integrated circuit formed in a signal wiring layer according to an embodiment. Specifically, FIG. 9 is a top plan view of the signal wiring layer 330 (refer to FIG. 3) according to an embodiment, and is a top plan view of a layout of the integrated circuit 900 after the placement operation (S820) (refer to FIG. 8) in which the plurality of standard cells SC are placed.

Referring to FIG. 9, the integrated circuit 900 according to an embodiment may include a plurality of power rails M1_R1, M1_R2, M1_R3, and M1_R4 extending in the X-axis direction. Each of the power rails M1_R1, M1_R2, M1_R3, and M1_R4 may be applied with a positive power source voltage (e.g., VDD) or a ground voltage (e.g., VSS). For example, the power rails M1_R1 and M1_R3 may be applied with the power source voltage VDD, and the power rails M1_R2 and M1_R4 may be applied with the ground voltage VSS.

In the placement operation (S820) according to an embodiment, the standard cells SC may be placed between the power rails M1_R1, M1_R2, M1_R3, and M1_R4 to which the positive power source voltage and the ground voltage are placed. The standard cell may include a logic cell, a filler cell, and the like.

The integrated circuit 900 according to an embodiment may include blockage regions 921 and 923 for placement of the sub-power tap cells. The blockage regions 921 and 923 may prohibit the placement of the standard cells SC. In an embodiment, the blockage regions 921 and 923 may extend in the vertical Y-axis direction across all rows distinguished by the plurality of power rails M1_R1, M1_R2, M1_R3, and M1_R4. The blockage regions 921 and 923 may be separated from each other at regular intervals D in the X-axis direction. The interval D may be a predetermined interval to prevent power problems from occurring in the integrated circuit 900, such as a drop in current-resistance (IR). The blockage regions 921 and 923 may have a size of 2Ncpp in the X-axis direction. This may be a size according to the minimum length rule for the through silicon via region included in the power tap cell formed by the sub-power tap cell.

In the design method according to an embodiment, the sub-power tap cell is placed after the placement of the standard cells SC, and thus the restrictions of the standard cells SC, which need to be considered in the relationship with the power tap cell PTC when placing the standard cells SC according to the comparative example can be reduced.

FIG. 10 is a top plan view of a sub-power tap cell provided by a cell library according to an embodiment. Specifically, it shows a type of sub-power tap cell that a cell library 1000 provides in order to satisfy the design rule with adjacent standard cells. According to an embodiment, a power tap cell with size of 2Ncpp may be formed by placing two sub-power tap cells with a size of Nopp together.

FIG. 10 illustrates sub-power tap cells of Nopp size with active layers different in width provided by the cell library. Each sub-power tap cell may include through silicon via regions 1011 and 1013 and active layers 1012 and 1014. The cell library 1000 may provide a sub-power tap cell including an active layer 1012 with a first width W1 and an active layer 1014 with a second width W2 that is different from the first width W1. The semiconductor design tool may select and place the sub-power tap cells including the same active layer width based on the width of the active layer of adjacent standard cells. Here, it is shown that there are two sub-power tap cells of Nopp size provided by the cell library according to the width of the active layer, but this is not limited thereto, and there are more types of sub-power tap cells may be stored in the cell library depending on the width of the active layer of the standard cell.

Portion (b) in FIG. 10 illustrates sub-power tap cells of Ncpp size each including a different implant layer according to a threshold voltage of the cell. The respective sub-power tap cells may include through silicon via regions 1021 and 1023 and implant layers 1022, 1032, and 1042. The cell library 1000 may provide sub-power tap cells including a first implant layer 1022, a second implant layer 1032, and a third implant layer 1042 depending on a threshold voltage of a cell. The semiconductor design tool may select and place sub-power tap cells including the same implant layer based on the implant layer of the adjacent standard cell. Here, it is shown that there are three sub-power tap cells of Nopp size provided by the cell library according to the width of the implant layer, but this is not limited thereto, and more types of sub-power tap cells may be stored in the cell library depending on the width of the implant layer of the standard cell.

As described above, because the sub-power tap cell include the active layer and the implant layer, the sub-power tap cell provided by the cell library 1000 may be a combination of the active layers according to portion (a) in FIG. 10 and the implant layers of portion (b) in FIG. 10 in various ways.

In addition, according to the minimum length rule for the length of the through silicon via region of the power tap cell, the semiconductor design tool considers a direction (orientation) of each sub-power tap cell and place sub-power tap cells such that the through silicon vias in the through silicon via regions 1011, 1013, 1021, 1023 are in contact with each other. In this regard, the through silicon via regions 1011, 1013, 1021, and 1023 of the sub-power tap cell may contact each other. Through such a placement, a power tap cell of 2Ncpp size can be formed.

The cell library provides sub-power tap cells of Ncpp size with separated 2Ncpp size power tap cells, thereby reducing the burden of providing excessive cell types for the plurality of standard cells.

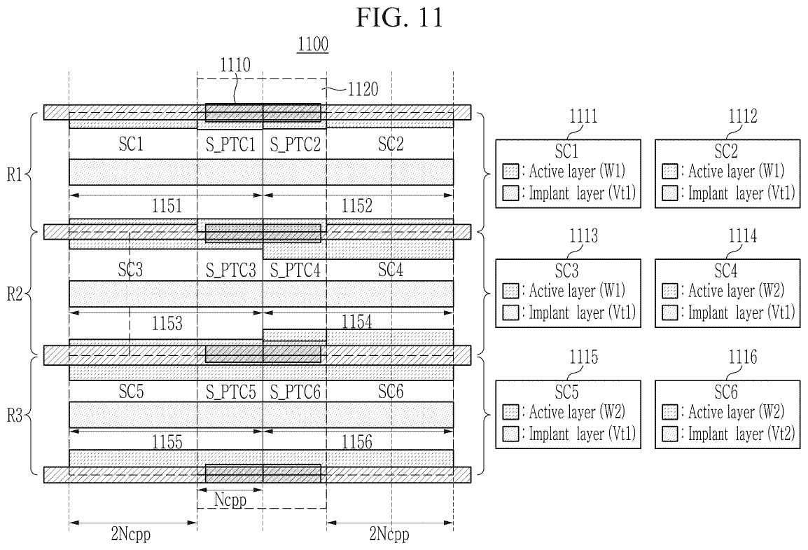

FIG. 11 schematically illustrates a part of an integrated circuit formed in a signal wiring layer according to an embodiment. Specifically, FIG. 11 is a top plan view of the signal wiring layer 330 (refer to FIG. 3), which illustrates a layout of the integrated circuit 1100 in which a plurality of standard cells and sub-power tap cells according to an embodiment are placed.

In accordance with the design method of FIG. 8, sub-power tap cells S_PTC1, . . . , and S_PTC6 of Ncpp size may be placed in a predetermined blockage region 1120 after the plurality of standard cells SC1, . . . , and SC6 are placed. FIG. 11 illustrates integrated circuit 1100 in which the sub-power tap cell is placed after the plurality of standard cells SC1, . . . , and SC6 are placed, and it is assumed that the plurality of standard cells SC1, . . . , and SC6 all have the 2Ncpp size, and the minimum length Mcpp according to the minimum length rule for the active layer and the implant layer is 3Ncpp, but is not limited thereto.

In the placement operation (S820 of FIG. 8) according to an embodiment, the plurality of standard cells SC1, . . . , and SC6 may be placed. In order to satisfy design rules of predefining an active layer and an implant layer of the sub-power tap cell S_PTC, the semiconductor design tool needs to select and place the sub-power tap cell S_PTC corresponding to active layers and implant layers of the standard cells SC1, . . . , and SC6 placed adjacent to a pre-allocated blockage region 1120.

In a first row R1, a first standard cell SC1 includes (1111) an active layer of a first width W1 and an implant layer according to a first threshold voltage Vt1 (1111), and a second standard cell SC2 may include (1112) an active layer of the first width W1 and an implant layer according to the first threshold voltage Vt1. In an embodiment, the semiconductor design tool may select a sub-power tap cell of Ncpp size to be placed in the blockage region 1120 based on a standard cell adjacent to the blockage region 1120. The semiconductor design tool may select a sub-power tap cell based on a width of an active layer and an implant layer according to the threshold voltage of a standard cell adjacent to the blockage region 1120. For example, because the first standard cell SC1 includes the active layer of the first width W1 and the implant layer according to the first threshold voltage Vt1, the semiconductor design tool may select a first sub-power tap cell S_PTC1 including the active layer of the first width W1 and the implant layer according to the first threshold voltage Vt1 among a plurality of sub-power tap cells stored in the cell library and place the selected cell adjacent to the first standard cell SC1. In addition, because the second standard cell SC2 also includes the active layer of the first width W1 and the implant layer according to the first threshold voltage Vt1, the semiconductor design tool may select a second sub-power tap cell S_PTC2 including the active layer of the first width W1 and the implant layer according to the first threshold voltage Vt1 among the plurality of sub-power tap cells stored in the cell library and place the selected cell adjacent to the second standard cell SC2. When placing the first sub-power tap cell S_PTC1 and the second sub-power tap cell S_PTC2, the semiconductor design tool may adjust orientations of the sub-power tap cells such that through silicon vias in the through silicon via region 1110 may contact each other. Through such a placement, the sub-power tap cells S_PTC1 and S_PTC2 in the first row R1 may satisfy minimum length (Mcpp) according to the minimum length rules 1151 and 1152 for the lengths of the active layer and the implant layer in the relationship with the adjacent standard cells SC1 and SC2. Mcpp, which is a minimum length according to the minimum length rule for active layer and the implant layer is assumed to be 3Ncpp, but this is not restrictive.

In a second row R2, a third standard cell SC3 includes (1113) the active layer of the first width W1 and the implant layer according to the first threshold voltage Vt1, and a fourth standard cell SC4 includes (1114) an active layer of a second width W2, which is different from the first width W1, and the implant layer according to the first threshold voltage Vt1. In an embodiment, the semiconductor design tool may select a sub-power tap cell of Ncpp size to be placed in the blockage region 1120 based on a standard cell adjacent to the blockage region 1120. The semiconductor design tool may select a sub-power tap cell based on a width of an active layer and an implant layer according to a threshold voltage of the standard cell adjacent to the blockage region 1120. For example, because the third standard cell SC3 includes the active layer of the first width W1 and the implant layer according to the first threshold voltage Vt1, the semiconductor design tool may select a third sub-power tap cell S_PTC3 including the active layer of the first width W1 and the implant layer according to the first threshold voltage Vt1 among the plurality of sub-power tap cells stored in the cell library and place the selected cell adjacent to the third standard cell SC3. In addition, because the fourth standard cell SC4 includes the active layer of the second width W2, which is different from the first width W1, and the implant layer according to the first threshold voltage Vt1, the semiconductor design tool may select a fourth sub-power tap cell S_PTC4 via including the active layer of the second width W1 and the implant layer according to the first threshold voltage Vt1 among the plurality of sub-power tap cells stored in the cell library and place the selected cell adjacent to the fourth standard cell SC4. Through such a placement, the sub-power tap cells S_PTC3 and S_PTC4 in the second row R2 may satisfy minimum length (Mcpp) according to the minimum length rules 1153 and 1154 for the active layer and the implant layer in the relationship with the adjacent standard cells SC3 and SC4. Mcpp, which is a minimum length according to the minimum length rule for active layer and the implant layer is assumed to be 3Ncpp, but this is not restrictive.

In a third row R3, a fifth standard cell SC5 may include the active layer of the second width W2 and the implant layer according to the first threshold voltage Vt1, and a sixth standard cell SC6 may include the active layer of the second width W2 and an implant layer according to a second threshold voltage Vt2, which is different from the first threshold voltage Vt1. In an embodiment, the semiconductor design tool may select a sub-power tap cell of Nopp size to be placed in the blockage region 1120 based on a standard cell adjacent to the blockage region 1120. The semiconductor design tool may select a sub-power tap cell based on the width of the active layer and the implant layer according to the threshold voltage of the standard cell adjacent to the blockage region 1120. For example, a fifth standard cell SC5 includes (1115) the active layer of the second width W2 and the implant layer according to the first threshold voltage Vt1, and thus the semiconductor design tool may select a fifth sub-power tap cell S_PTC5 including the active layer of the second width W2 and the implant layer according to the first threshold voltage Vt1 among the plurality of sub-power tap cells stored in the cell library and place the selected cell adjacent to the fifth standard cell SC5. In addition, a sixth standard cell SC6 includes the active layer of the second width W2 and the implant layer according to the second voltage Vt2, which is different from the first threshold voltage Vt1 (1116), and thus the semiconductor design tool may select a sixth sub-power tap cell S_PTC6 including the active layer of the second width W2 and the implant layer according to the second threshold voltage Vt2 among the plurality of sub-power tap cells stored in the cell library and place the selected cell adjacent to the sixth standard cell SC6. Through such a placement, the sub-power tap cells S_PTC5 and S_PTC6 in the third row R3 may satisfy minimum length (Mcpp) according to the the minimum length rules 1155 and 1156 for the active layer and the implant layer in the relationship with the adjacent standard cells SC5 and SC6. Mcpp, which is a minimum length according to the minimum length rule for active layer and the implant layer is assumed to be 3Ncpp, but this is not restrictive.

As described, the semiconductor design tool places two sub-power tap cells of Nopp size selected based on the standard cell adjacent to the blockage region 1120 together, thereby satisfying the minimum length rule for the active layer and the implant layer in the relationship with the adjacent standard cell and satisfying the minimum length rule for the through silicon via region of the power tap cell.

The above description has been made assuming that all standard cells adjacent to the power tap cell are cells of 2Ncpp size. However, standard cells may have various sizes beyond 2Ncpp, and considerations when placing sub-power tap cells may differ depending on the size of the standard cells. Hereinafter, cases where the sizes of standard cells adjacent to a power tap cell vary will be described.

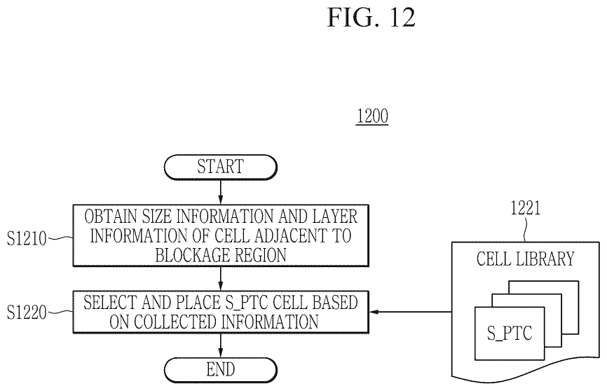

FIG. 12 is a flowchart of a placement method of sub-power tap cells according to an embodiment. Referring to FIG. 8, as described above, placement of sub-power tap cells may be performed after placement of standard cells is completed.

In an embodiment, the semiconductor design tool may identify adjacent standard cells on both sides of a predetermined blockage region to place sub-power tap cells, and may obtain size information of the adjacent standard cells and an active layer and an implant layer information of the adjacent standard cell (S1210). As previously described, the standard cells may be placed in regions other than the predetermined blockage region to place the sub-power tap cells, and the semiconductor design tool may identify the standard cells adjacent to the blockage region based on coordinate information of the blockage region and the standard cells. The semiconductor design tool may identify the standard cells adjacent to the blockage region and obtain size information of the identified standard cells and information on the active layer and the implant layer of the standard cells. For example, it is possible to collect information on whether the size of the standard cells adjacent to the blockage region is greater than or equal to Mcpp, a width of the active layer of the standard cells, and implant layer information according to a threshold voltage of the standard cell.

In an embodiment, the semiconductor design tool may select a sub-power tap cell S_PTC to be placed in the blockage region among a plurality of sub-power tap cells S_PTC stored in the cell library 1221 based on the collected information and place the selected sub-power tap cell S_PTC (S1220). As described above with reference to the drawings, the semiconductor design tool may select a sub-power tap cell of Nopp size among the plurality of sub-power tap cells S_PTC stored in the cell library 1221 based on the size information of the adjacent standard cells and the information on the active layer and the implant layer.

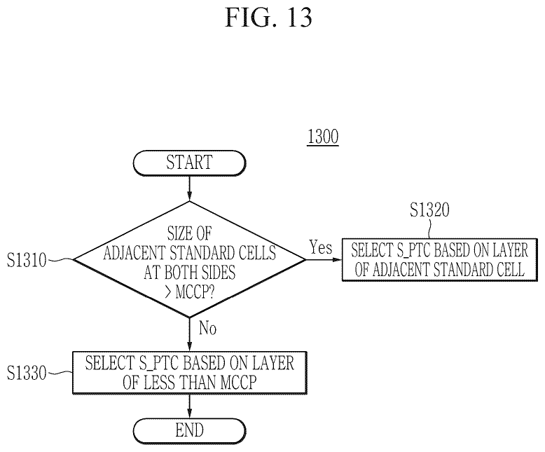

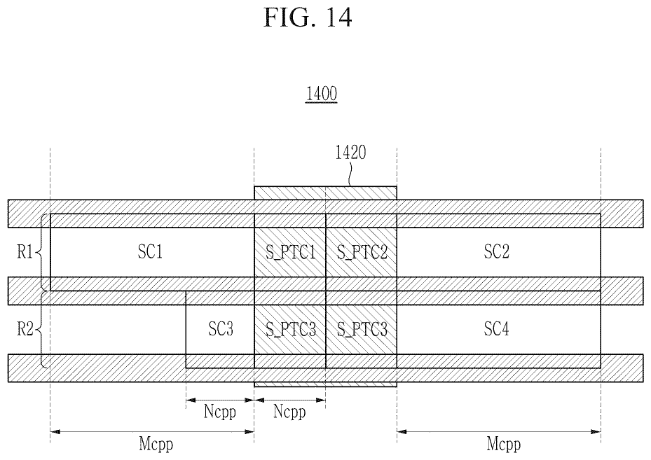

FIG. 13 is a flowchart of a placement method of sub-power tap cells according to an embodiment, and FIG. 14 schematically illustrates a part of an integrated circuit designed using the placement method of the sub-power tap cell of FIG. 13. Specifically, the drawing is provided for description of the placement method of the sub-power tap cells when at least one of standard cells placed on both sides adjacent to a blockage region is larger than the Mcpp size.

In an embodiment, a semiconductor design tool may determine whether the standard cells placed at both sides while tool adjacent to the blockage region where the sub-power tap cell is to be placed are greater than a first size, for example, the Mcpp size (S1310). Referring to FIG. 14, a first row R1 of an integrated circuit 1400 may include a blockage region 1420 where the sub-power tap cell is to be placed, and standard cells SC1 and SC2 adjacent to the blockage region 1420. The semiconductor design tool may determine whether sizes of the standard cells SC1 and SC2 adjacent to the blockage region 1420 of the first row R1 are greater than or equal to Mcpp.

In an embodiment, based on whether the sizes of the standard cells SC1 and SC2 adjacent to the blockage region 1420 are both greater than Mcpp, the semiconductor design tool may select sub-power tap cells including the same active layer and implant layer as each of the adjacent standard cells among the Ncpp-sized sub-power tap cells stored in a cell library (S1320). Referring to FIG. 14, in the first row R1, when the sizes of the standard cells SC1 and SC2 are greater than Mcpp, the standard cells themselves may satisfy minimum length rules for the active layer and the implant layer. Thus, the semiconductor design tool may select a sub-power tap cell S_PTC1 that includes the same layers as the active layer and the implant layer of the first standard cell SC1 and a sub-power tap cell S_PTC2 that includes the same layers as the active layer and the implant layer of the second standard cell SC2 from the cell library, and place the selected cells in the blockage region 1420 to comply with the design rules for the active layer and implant layer of the sub-power tap cells S_PTC1 and S_PTC2. Because the sub-power tap cells S_PTC1 and S_PTC2 of Nopp size are placed together, a power tap cell of 2Ncpp size can be formed. Lengths of the active layer and the implant layer of the sub-power tap cells S_PTC1 and S_PTC2 may satisfy the minimum length rule.

In an embodiment, when one of the standard cells placed on both sides adjacent to the blockage region is smaller than the first size, for example, Mcpp size, that is, smaller than the Mcpp size, the semiconductor design tool may select a sub-power tap cell including the same active layer and implant layer as a standard cell of less than the Mcpp size (S1330). Referring to FIG. 14, a second row R2 of the integrated circuit 1400 may include a blockage region 1420 where a sub-power tap cell will be placed and standard cells SC3 and SC4 adjacent to the blockage region 1420. The semiconductor design tool may select a sub-power tap cell to comply with the minimum length rules for the active layer and the implant layer when one standard cell SC3 among the standard cells SC3 and SC4 that are adjacent to the blockage region 1420 have a size less than the Mcpp size. Thus, the semiconductor design tool selects a sub-power tap cell S_PTC3 including the same layers as the active layer and the implant layer of the standard cell SC3 of which the size is smaller than the Mcpp size from the cell library, and continuously places the selected cell in the blockage region 1420. A power tap cell of 2Ncpp size may be formed by placing two sub-power tap cells S_PTC3 of Nopp size together. Lengths of the active layer and the implant layer of the sub-power tap cell S_PTC3 may satisfy the minimum length rules, and simultaneously, lengths of the active layer and the implant layer of the standard cell SC3 may satisfy the minimum length rules.

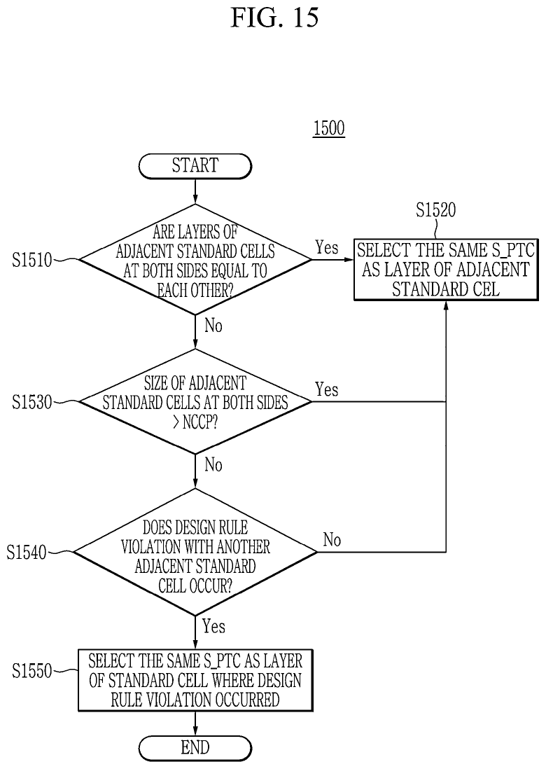

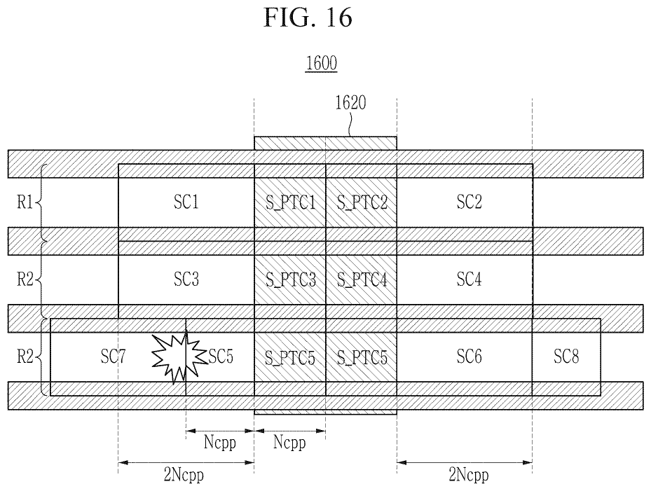

FIG. 15 is a flowchart of a placement method of sub-power tap cells according to an embodiment, and FIG. 16 schematically illustrates a part of an integrated circuit designed using the placement method of the sub-power tap cell of FIG. 15. Specifically, the drawing is provided for description of the placement method of the sub-power tap cells when at least one of standard cells placed on both sides adjacent to a blockage region where sub-power tap cells are placed is larger than the Mcpp size.

In an embodiment, a semiconductor design tool may determine whether active layers and implant layers of the standard cells disposed on both sides of the blockage region are equal to each other when all the standard cells placed at both sides adjacent to the blockage region where the sub-power tap cell is to be placed are less than the Mcpp size (S1510). In an embodiment, based on determining active layers and the implant layers of the standard cells disposed on both sides of the blockage region are equal to each other, the semiconductor design tool may select a sub-power tap cell of which an active layer and an implant layer are the same as those of the adjacent standard cells from among sub-power tap cells of Nopp size stored in a cell library (S1520). Referring FIG. 16, a first row R1 of an integrated circuit 1600 may include a blockage region 1620 where a sub-power tap cell is to be placed, and standard cells SC1 and SC2 disposed adjacent to the blockage region 1620. The semiconductor design tool may determine whether active layers and implant layers of the standard cells SC1 and SC2 that are adjacent to the blockage region 1620 of the first row R1 are equal to each other. When the active layers and the implant layers of the standard cells SC1 and SC2 that are adjacent to the blockage region 1620 are equal to each other, the semiconductor design tool may select a sub-power tap cell S_PTC1 of which an active layer and an implant layer are the same as those of the adjacent standard cells SC1 and SC2 and continuously place the selected cell in the blockage region 1620. A power tap cell of 2Ncpp size may be formed by placing two sub-power tap cells S_PTC1 of Ncpp size. Lengths of the active layer and the implant layer of the sub-power tap cell (S_PTC1) may satisfy the minimum length rule.

In an embodiment, based on determining the active layers and the implant layers of the standard cells SC1 and SC2 that are adjacent to the blockage region 1620 are not equal to each other, the semiconductor design tool may determine whether the sizes of the standard cells placed on both sides exceed Nopp (S1530). In an embodiment, based on determining the sizes of the standard cells placed on both sides of the blockage region exceed Ncpp, the semiconductor design tool may select sub-power tap cells of which active layers and implant layers are the same as those of the adjacent standard cells from sub-power tap cells of Nopp size stored in the cell library (S1520). Referring to FIG. 16, when it is determined active layers and/or implant layers of standard cells SC3 and SC4 that are adjacent to a blockage region 1620 of a second row R2 of the integrated circuit 1600 are different from each other and sizes of the standard cells SC3 and SC4 are a second size that is different from a first size, for example, the sizes are 2Ncpp size, that is the sizes of the standard cells SC3 and SC4 respectively exceed Ncpp, the semiconductor design tool may select and place sub-power tap cells S_PTC3 and S_PTC4 with the same active layer and implant layer as each of the adjacent standard cells. For example, the semiconductor design tool may select a sub-power tap cell S_PTC3 including the same layers as those of the third standard cell SC3 and a sub-power tap cell S_PTC4 including the same layers as those of the fourth standard cell SC4 from the cell library and place the selected cells in the blockage region 1620. A power tap cell of 2Ncpp size may be formed by placing the sub-power tap cells S_PTC3 and S_PTC4 of Nopp size together. Lengths of the active layer and the implant layer of the sub-power tap cells S_PTC3 and S_PTC4 may satisfy the minimum length rule.

In an embodiment, when at least one of the standard cells adjacent the blockage region has a third size that is different from the second size, for example, Nopp size, the semiconductor design tool may determine whether the standard cell adjacent to the blockage region violates the design rules for the active layer and the implant layer in the relationship with the standard cell placed adjacent to the blockage region in the opposite direction (S1540). In an embodiment, based on determining the standard cell adjacent to the blockage region satisfies the design rules for the active layer and the implant layer in the relationship with the standard cell placed adjacent to the blockage region in the opposite direction, the semiconductor design tool may select a sub-power tap cell with the same active layer and the implant layer as those of each of adjacent standard cells (S1520). In an embodiment, based on determining one of the standard cells adjacent to the blockage region violates the design rules for the active layer and the implant layer in the relationship with the standard cell placed adjacent to the blockage region in the opposite direction, the semiconductor design tool may select sub-power tap cells containing the same layers as those of the standard cell that violates the design rules (S1550). Referring to FIG. 16, in a third row R3, one standard cell SC5 among standard cells SC5 and SC6 adjacent to the blockage region 1620 may be Ncpp size. In this case, the semiconductor design tool may determine whether the standard cells SC5 and SC6 adjacent to the blockage region 1620 violate the design rules for the active layer and the implant layer in the relationship with standard cells SC7 and SC8 disposed adjacent to the blockage region 1620 in the opposite direction. When one standard cell SC5 of the standard cells SC5 and SC6 adjacent to the blockage region 1620 violates the design rule in the relationship with the other adjacent standard cell SC7, the semiconductor design tool may select a sub-power tap cell S_PTC5 containing the same layers as the active layer and the implant layer of the standard cell SC5 from the cell library and continuously place the selected cell in the blockage region 1620. A power tap cell of 2Ncpp size may be formed by placing two sub-power tap cells S_PTC5 of Ncpp size. Lengths of the active layer and the implant layer of the standard cell SC5 and the sub-power tap cell S_PTC3 may satisfy the minimum length rule.

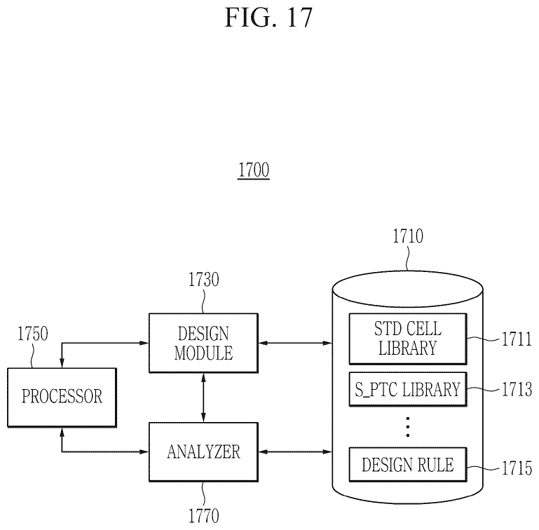

FIG. 17 schematically illustrates a design system of a semiconductor device according to an embodiment.

A design system 1700 may include a storage device 1710, a design module 1730, a processor 1750, and an analysis module 1770. The design system 1700 of FIG. 17 may perform at least a part of the design operation of the semiconductor device described with reference to the design method of the semiconductor device of FIG. 8 to FIG. 16. The design system 1700 may be implemented as an integrated device and, accordingly, may be referred to as a design device. The design system 1700 may be provided as a dedicated device for designing integrated circuits of semiconductor devices, but may also be a computer for running various simulation tools or design tools.

The storage device 1710 according to an embodiment may include a standard cell library 1711, a sub-power tap cell library 1713, and a design rule 1715. In an embodiment, the sub-power tap cell library 1713 may store information on the sub-power tap cell of Ncpp size. In an embodiment, the sub-power tap cell library 1713 may store sub-power tap cells including active layers of various widths and various implant layers. The standard cell library 1711, the sub-power tap cell library 1713, and the design rule 1715 may be provided to the design module 1730 and the analysis module 1770 from the storage device 1710. The number of cell libraries included in the storage device 1710 may be changed in various ways.

The design module 1730 according to an embodiment may receive the standard cell library 1711, the sub-power tap cell library 1713, and the design rule 1715 from the storage device 171 and perform the design operations of the semiconductor device discussed above with reference to FIG. 8 to FIG. 16. In an embodiment, the design module 1730 may perform a batch operation for a standard cell using the standard cell library 1711 and then perform a batch operation for a sub-power tap cell using the sub-power tap cell library 1713. Here, the term “module” may represent hardware, such as a field programmable gate array (FPGA) or an application specific integrated circuit (ASIC), or a combination thereof.

The processor 1750 may be used by the design module 1730 and the analysis module 1770 to perform calculations. For example, the processor 1750 may include a microprocessor, an application processor (AP), a digital signal processor (DSP), a graphic processing unit (GPU), and the like. In FIG. 17, only one processor 215 is illustrated, but depending on embodiments, the design system 1700 may include a plurality of processors. The processor 1750 may include a cache memory to improve computing performance.

The analysis module (i.e., analyzer) 1770 may perform analysis and verification of the layout generated by the design module 1730 during or after performing the design operation of the semiconductor device of FIG. 8 to FIG. 16. In an embodiment, the analysis module 1770 may analyze and verify whether the layers included in the standard cell and power tap cell satisfy the design rule based on the design rule 1715 received from the storage device 1710.

While aspects of embodiments have been particularly shown and described, it will be understood that various changes in form and details may be made therein without departing from the spirit and scope of the following claims.

What is claimed is:

1. A method of manufacturing a semiconductor integrated circuit including a first region and a remaining region excluding the first region, the method comprising:
placing standard cells in the remaining region;
generating a routing structure that connects the standard cells;
placing sub-power tap cells in the first region based on a predefined design rule; and
verifying whether the sub-power tap cells and the standard cells comply with the predefined design rule.

2. The method of manufacturing the semiconductor integrated circuit of claim 1, wherein the placing the sub-power tap cells in the first region comprises:
identifying a first standard cell and a second standard cell placed adjacent to the first region in a first row among a plurality of rows of the semiconductor integrated circuit;
acquiring first layer information and second layer information of the first standard cell and the second standard cell;
selecting and placing a sub-power tap cell stored in a cell library based on the first layer information and the second layer information.

3. The method of manufacturing the semiconductor integrated circuit of claim 2, wherein the selecting and placing the sub-power tap cell stored in the cell library based on the first layer information and the second layer information comprises:
selecting a first sub-power tap cell including a first layer that corresponds to a first layer of the first standard cell and a second layer that corresponds to a second layer of the first standard cell, among sub-power tap cells stored in the cell library;
selecting a second sub-power tap cell including a first layer that corresponds to a first layer of the second standard cell and a second layer that corresponds to a second layer of the second standard cell; and
placing the first sub-power tap cell in the first region adjacent to the first standard cell and placing the second sub-power tap cell in the first region adjacent to the second standard cell.

4. The method of manufacturing the semiconductor integrated circuit of claim 3, wherein the first sub-power tap cell and the second sub-power tap cell each further comprises a via region including a through silicon via, and
wherein the placing the first sub-power tap cell in the first region adjacent to the first standard cell and placing the second sub-power tap cell in the first region adjacent to the second standard cell comprises controlling an orientation of the first sub-power tap cell and the second sub-power tap cell such that the respective via regions of the first sub-power tap cell and the second sub-power tap cell contact each other.

5. The method of manufacturing the semiconductor integrated circuit of claim 3, wherein the first sub-power tap cell and the second sub-power tap cell form one power tap cell.

6. The method of manufacturing the semiconductor integrated circuit of claim 2, wherein the predefined design rule is a minimum length rule for lengths of a first layer and a second layer.

7. The method of manufacturing the semiconductor integrated circuit of claim 2, wherein the identifying the first standard cell and the second standard cell placed adjacent to the first region comprises obtaining size information of the first standard cell and the second standard cell.

8. The method of manufacturing the semiconductor integrated circuit of claim 7, further comprising:
determining whether first layers and second layers of the first standard cell and the second standard cell are equal to each other based on the first standard cell and the second standard cell both being smaller than a first size along a first direction;
determining whether a size of one of the first standard cell and the second standard cell is a second size along the first direction, which is different from the first size, based on the first layers and the second layers of the first standard cell and the second standard cell being different from each other; and
determining whether the first standard cell and a third standard cell that is adjacent to the first standard cell in an opposite direction of the first region comply with the predefined design rule, based on the first standard cell having the second size along the first direction.

9. The method of manufacturing the semiconductor integrated circuit of claim 8, further comprising selecting the sub-power tap cell including layers that correspond to those of the first layers and the second layers, from sub-power tap cells stored in the cell library, based on the first layers and the second layers of the first standard cell and the second standard cell being equal to each other.

10. The method of manufacturing the semiconductor integrated circuit of claim 9, further comprising continuously placing the selected sub-power tap cell in the first row of the first region.

11. The method of manufacturing the semiconductor integrated circuit of claim 8, further comprising, based on the first layers and the second layers of the first standard cell and the second standard cell being different from each other, and the first standard cell and the second standard cell all having a third size along the first direction that is different from the second size:
selecting a first sub-power tap cell including a first layer that corresponds to the first layer of the first standard cell and a second layer that corresponds to the second layer of the first standard cell, among sub-power tap cells stored in the cell library;
selecting a second sub-power tap cell including a first layer that corresponds to the first layer of the second standard cell and a second layer that corresponds to the second layer of the second standard cell;
placing the first sub-power tap cell in the first region adjacent to the first standard cell and placing the second sub-power tap cell in the first region adjacent to the second standard cell.

12. The method of manufacturing the semiconductor integrated circuit of claim 8, further comprising selecting the sub-power tap cell including layers corresponding to those of a first layer and a second layer of the first standard cell, from among the sub-power tap cells stored in the cell library, based on the first standard cell and the third standard cell violating the predefined design rule.

13. The method of manufacturing the semiconductor integrated circuit of claim 1, wherein the sub-power tap cells have 1 contacted poly pitch (cpp) size.

14. A semiconductor integrated circuit comprising:
a first power rail extending in a first direction;
a second power rail that extends in the first direction and is spaced apart from the first power rail in a second direction that crosses the first direction;
a first standard cell between the first power rail and the second power rail; and
a first power tap cell adjacent to the first standard cell in the first direction, and comprising a first region and a second region, the first region comprising a first via electrically connecting an external power wire and the first power rail, and the second region comprising a second via electrically connecting an external power wire and the second power rail, a first active layer having a first width in the second direction, and a second active layer having a second width in the second direction that is different from the first width.

15. The semiconductor integrated circuit of claim 14, wherein the first active layer and the second active layer have equal lengths in the first direction.

16. The semiconductor integrated circuit of claim 14, wherein the first standard cell comprises an active layer of the first width in the second direction.

17. The semiconductor integrated circuit of claim 16, further comprising a second standard cell between the first power rail and the second power rail, the second standard cell comprising an active layer having the second width in the second direction and being adjacent to the first power tap cell in the first direction.

18. The semiconductor integrated circuit of claim 14, wherein a length of the first region and a length of the second region in the first direction satisfy a minimum length rule according to a predefined design rule.

19. The semiconductor integrated circuit of claim 14, further comprising a second power tap cell that is spaced apart from the first power tap cell by a predetermined distance in the first direction.

20. A semiconductor device comprising:
a substrate;
a first layer on a first side of the substrate and comprising a power distribution network; and
a second layer on a second side of the substrate and comprising a first power rail extending in a first direction, a first through silicon via extending through the substrate in a second direction that crosses the first direction from the power distribution network to the first power rail and having a first length in the first direction, and a second through silicon via contacting the first through silicon via, adjacent the first through silicon via in the first direction, extending through the substrate in the second direction from the power distribution network to the first power rail, and having the first length in the first direction.
